(19) United States
(12) Patent Application Publication
(10) Pub. No.: US 2009/0235247 A1
(43) Pub. Date: Sep. 17, 2009

(54) APPARATUS AND METHOD FOR CHECKING IDLE PERIOD OF VIRTUAL MACHINE, AND COMPUTER READABLE RECORDING MEDIUM FOR EMBODYING THE METHOD

(75) Inventors: Woong-suk CHO, Seoul (KR); Seung-bum CHUNG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/246,630

(22) Filed: Oct. 7, 2008

(30) Foreign Application Priority Data
Mar. 14, 2008 (KR) 10-2008-0023930

(51) Int. Cl. G06F 9/455

(52) U.S. Cl. 718/1

(57) ABSTRACT

An apparatus and method for checking an idle period of a virtual machine, and a computer readable recording medium for embodying the method. The apparatus includes a thread counting unit which counts a total number of threads that are under execution and a monitor thread which detects the idle period of the virtual machine based on the total number of threads that are under execution.

### CROSS-REFERENCE TO RELATED PATENT APPLICATIONS

This application claims priority from Korean Patent Application No. 10-2008-0023930, filed on Mar. 14, 2008 in the Korean Intellectual Property Office, the disclosure of which is incorporated herein in its entirety by reference.

### BACKGROUND OF THE INVENTION

1. Field of the Invention

Apparatuses and methods consistent with the present invention relate to a virtual machine, and more particularly, to checking an idle period of a virtual machine in order to use an idle time of the virtual machine.

2. Description of the Related Art

As communications via networks have become popular, various devices and systems can be used while being connected to one another via a network. Such a change in the communication network environment has triggered a need for development of a program execution environment where the same software can operate in various architectures, and a virtual machine has been introduced accordingly. It is possible to allow a program to perform the same operations in various architectures by compiling the program into an instruction set, e.g., bytecode, which is used by the virtual machine, and then executing an output generated as the result of compiling in the virtual machine realized to be suitable for each architecture. The virtual machine has an advantage in terms of being able to perform the same program in various platforms, and thus, the range of applications thereof has been increased ranging from personal computers (PCs) to consumer electronics (CE) products, such as digital televisions (DTVs) and set-top boxes.

However, when the virtual machine is installed as middleware in CE products, an idle period in which the virtual machine stands by without operating is longer than a period in which the virtual machine operates in order to execute a program. Use of the idle period makes it possible to efficiently perform various operations, such as garbage collection (GC), compilation, and decompilation, which are to be performed in the virtual machine.

Since the above operations are mainly called in a period in which a large number of objects are generated and the system actively operates, the performance of the virtual machine can be improved by performing some of the operations in the idle period. In particular, if an operation, such as the GC, during which the system may be temporarily stopped, is distributed over the idle period in which the system does not operate, not only the performance of the virtual machine, but also response time to the user by the virtual machine, can be improved.

Accordingly, it is very important to provide a technique of precisely and quickly checking an idle period of the virtual machine without causing overhead to the system. However, a related art method of checking an idle period of the virtual machine does not satisfy the needs described above.

The virtual machine will now be briefly described prior to explaining a related art method of detecting an idle period.

FIG. 1 is a block diagram of a Java virtual machine 101 that represents virtual machines. A class loader 102 checks whether compiled bytecode (an instruction set that can be executed by the virtual machine) is correct or complies with security rules, and then, the bytecode is reconstructed and loaded so that the virtual machine can understand it. Reconstructed codes are executed by an execution engine 103. The execution engine 103 may be divided into an interpreter 104 and a compiler 105. The interpreter 104 of the virtual machine interprets and executes each of bytecodes. However, in this case, the speed of executing each of the bytecodes is low, and thus, in general, each of the bytecodes is recompiled into a machine language according to each platform. A just-in-time (JIT) compiler module 105 performs code recompiling, that is, it transforms bytecode into a machine language during the operation of the virtual machine. One of the main characteristics of the Java virtual machine 101 is that memory management is performed by the virtual machine and not by a programmer. A garbage collector 106 performs memory management. A memory region that the virtual machine uses is managed as a heap region, and the garbage collector 106 is a module that manages the heap region. The garbage collector 106 performs not only memory allocation and cancellation but also management of the heap region to ensure efficient use thereof Decompiler 107 is a module which deletes the machine codes compiled by JIT, when they are not in use or memory storage is insufficient, and allows the interpreter to use bytecode.

There are two related art techniques for checking an idle period of the virtual machine.

In the first technique for checking an idle period of the virtual machine, a profile interface supported within the virtual machine is used.

FIG. 2 is a block diagram of a Java Virtual Machine Profiling Interface (JVMPI) 202. A JVMPI 202 is an interface for profiling the virtual machine. A profile agent 203 collects data generated from execution of the virtual machine in a Java virtual machine 201 via the JVMPI 202, and transmits it to a profile front end 204.

For example, a Java virtual machine supports the JVMPI 202. For central processing unit (CPU) time profiling, the JVMPI 202 supports both a statistical sampling method and a code instrumentation method. In the statistical sampling method, a CPU time is measured by visiting all threads at predetermined intervals of time in order to check whether all the threads are executed. In the code instrumentation method, a CPU time is measured according to a period of time during which a CPU operates between entry and exit of the method. Whether there is a thread executed in the virtual machine is checked using one of these methods at predetermined intervals of time, and a period of time during which there is no thread executed can be determined as an idle period.

In the second technique for checking an idle period of the virtual machine, information supported by an operating system (OS) is used. For example, Linux provides system information by using a proc file system.

FIG. 3 is a block diagram illustrating a case where a CPU monitoring utility 302 is applied to a virtual machine 301. The CPU monitoring utility 302 is a module monitoring use of a CPU. If the CPU monitoring utility 302 is added to the virtual machine, a function of detecting an idle period of the virtual machine can be performed. Assuming that a Linux environment is used, the CPU monitoring utility 302 is present as a module of the virtual machine 301, and monitors the frequency of use of the CPU in the virtual machine 301 by receiving information from a /proc file system 304 provided by an OS (kernel) 303 through polling at predetermined intervals of time.

FIG. 4 is a flowchart illustrating a method of checking an idle period by adding a CPU monitoring utility inside a virtual machine. Here, the CPU monitoring utility will be referred to as a “CPU monitor”. Referring to FIGS. 3 and 4, the CPU monitor obtains information regarding use of a CPU from the /proc file system 304 provided by the kernel 303 through polling at predetermined intervals of time (operation 401). Next, only CPU information related to the virtual machine 301 is extracted from the information regarding use of the CPU (operation 402). If it is determined that a frequency of use of the CPU is zero in operation 402, a current state is determined to be an idle state (operation 403). If the current state is not the idle state, polling is performed again. If the current state is the idle state, this fact is reported (operation 404). Then, checking of an idle state is performed again.

As described above, it is possible to check whether a virtual machine enters an idle state during operation of the virtual machine, according to a related art method. However, it is difficult to directly apply the related art method to an actual execution environment, due to the following reasons.

First, when a profiling interface is used, a plurality of threads are checked at predetermined intervals of time and information regarding all periods of time during which a method is executed is stored, thereby causing overhead to the system.

Second, a very serious problem in terms of performing idle state checking using information provided from an OS is that necessary information must be obtained from the OS. If the OS does not support information regarding use of a CPU, the related art method is not available. Also, the states of all threads must be checked by receiving CPU information at predetermined intervals of time, thereby causing overhead to the system.

A purpose of detecting an idle period of a virtual machine is to increase the efficiency and performance of the virtual machine by detecting an idle period of the virtual machine during execution of the virtual machine. Thus, when runtime overhead is high as described above, the related art method is not available.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for checking an idle time inside a virtual machine without using conventional functions provided by a CPU or an OS, so that the efficiency and performance of the virtual machine can be improved using the idle time.

According to an aspect of the present invention, there is provided an apparatus for checking an idle period of a virtual machine, the apparatus comprising a thread counting unit which counts a total number of threads that are under execution; and a monitor thread which detects the idle period of the virtual machine based on the total number.

According to another aspect of the present invention, there is provided a virtual machine including an apparatus for checking an idle period of a virtual machine, where the apparatus includes a thread counting unit which counts a total number of threads that are under execution, and a monitor thread which detects the idle period of the virtual machine based on the total number.

According to another aspect of the present invention, there is provided a method of checking an idle period of a virtual machine, the method comprising counting a total number of threads that are under execution, and determining whether the virtual machine is in an idle state, based on the total number.

According to another aspect of the present invention, there is provided a computer readable recording medium having recorded thereon a computer program for executing a method of checking an idle period of a virtual machine, the method comprising counting a total number of threads that are under execution, and determining whether the virtual machine is in an idle state, based on the total number.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a Java virtual machine that represents a virtual machine according to the related art;

FIG. 2 is a block diagram of the Java Virtual Machine Profiling Interface (JVMPI) according to the related art;

FIG. 3 is a block diagram illustrating a case where a CPU monitoring utility is applied to a virtual machine according to the related art;

FIG. 4 is a flowchart illustrating a method of checking an idle period by adding a CPU monitoring utility inside a virtual machine according to the related art;

FIG. 5 is a block diagram of a virtual machine having an idle period checking apparatus according to an exemplary embodiment of the present invention;

FIG. 6 is a block diagram illustrating in detail an idle period checking apparatus according to an exemplary embodiment of the present invention;

FIG. 7 is a diagram illustrating a scenario for explaining a method of checking an idle period of a virtual machine;

FIGS. 8 and 9 are flowcharts illustrating a method of checking an idle period of a virtual machine, according to an exemplary embodiment of the present invention; and

FIG. 10 is a block diagram illustrating a layer structure of an environment where a Java virtual machine operates.

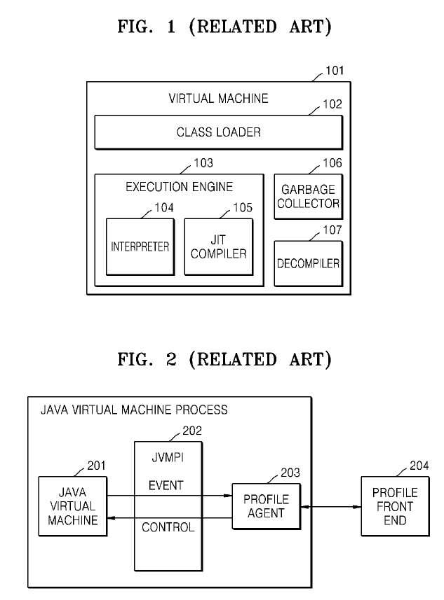

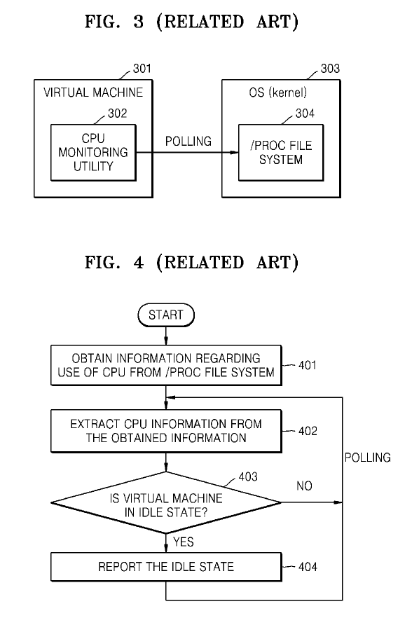

### DETAILED DESCRIPTION OF EXEMPLARY EMBODIMENTS OF THE INVENTION

Hereinafter, an apparatus and method for checking an idle period of a virtual machine according to exemplary embodiments of the present invention will be described in detail with reference to the accompanying drawings. Like reference numerals denote like elements throughout the drawings.

The present invention relates to detecting an idle period of a virtual machine and can be applied to not only PCs but also various CE devices, such as digital televisions DTVs and set-top boxes, in which the virtual machine can be installed. In particular, the advantage of the present invention can be increased when a virtual machine has a long idle period as in a CE device.

An idle period of a virtual machine can be defined as a period in which all threads executed by the virtual machine are blocked.

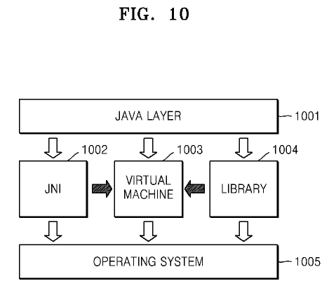

Referring to FIG. 10, a virtual machine system includes a virtual machine 1003 itself and external modules, such as a Java Native Interface (JNI) 1002 and a library 1004. Threads related to the virtual machine are largely categorized into two types: a thread that is an application program interface (API) provided by the virtual machine and is executed by the virtual machine 1003, and a thread that is executed by an external module and may be a user-defined API provided by the JNI 1002. First, exemplary embodiments of the present invention will be described with respect to a case where a thread for executing an API provided by the virtual machine is executed inside the virtual machine 1002. A case where a thread that is not provided by the virtual machine 1002 is executed by a module outside the virtual machine will be described later.

FIG. 5 is a block diagram of a virtual machine 101 having an idle period checking device 501 according to an exemplary embodiment of the present invention. The idle period checking device 501, disclosing a core of an exemplary embodiment of the present invention, is present in an execution engine 103, checks whether the virtual machine 101 is idle, and interacts with a garbage collector 106, a decompiler 107, etc.

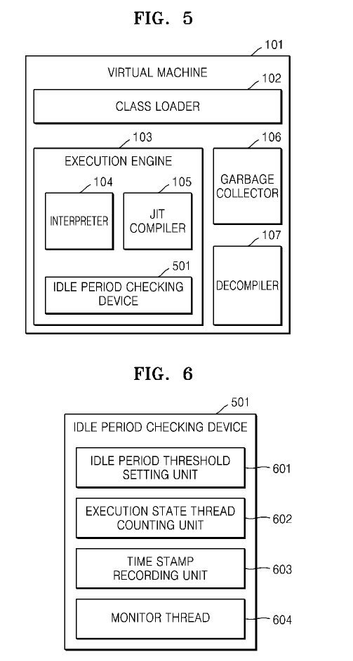

FIG. 6 is a block diagram illustrating in detail the idle period checking device 501 of FIG. 5, according to an exemplary embodiment of the present invention. The idle period checking device 501 includes an idle period threshold setting unit 601, an execution state thread counting unit 602, a time stamp recording unit 603, and a monitor thread 604.

The idle period threshold setting unit 601 sets a threshold for checking a duration of an idle state, which is needed to determine an idle period. That is, the threshold is a reference value indicating a least period of time during which all threads must be blocked and thus, the virtual machine can be determined to enter the idle period. It is possible to determine that the virtual machine enters the idle state right after all threads are blocked, but if, when the idle period is very short, other operations are performed, it may cause overhead to a thread that is to be newly executed. Accordingly, a threshold of the idle period needs to be appropriately adjusted in order to precisely detect the idle period. The execution state thread counting unit 602 indicates the total number of threads that are under execution, that is, that are not blocked. The execution state thread counting unit 602 updates the total number of threads that are actually being executed in real time by increasing the total number by 1 whenever one thread is generated and executed and by reducing the total number by 1 whenever one thread is blocked. If a thread is executed inside the virtual machine 1003, it is possible to check whether the thread is blocked. The time stamp recording unit 603 records time, i.e., a time stamp, when a last thread is blocked. The monitor thread 604 is initiated by the last blocked thread, and determines whether the virtual machine enters the idle period, based on the total number of threads that are under execution, the time stamp, and the idle period threshold.

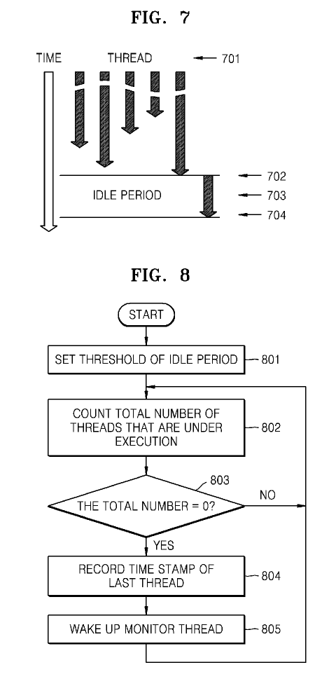

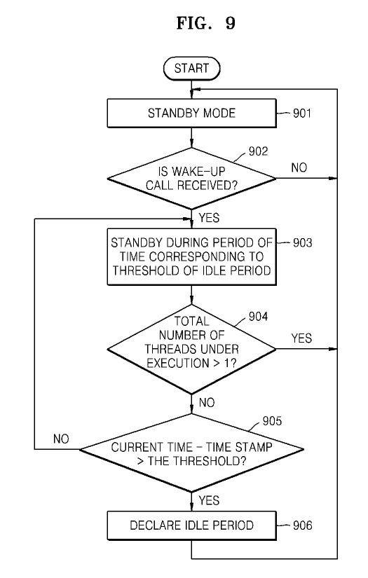

FIG. 7 is a diagram illustrating a scenario for explaining a method of checking an idle period of a virtual machine according to an exemplary embodiment of the present invention. FIGS. 8 and 9 are flowcharts illustrating a method of checking an idle period of a virtual machine according to an exemplary embodiment of the present invention.

A method of checking an idle period according to an exemplary embodiment of the present invention will now be described with reference to FIGS. 6 through 8.

First, a threshold of an idle period is set prior to checking an idle period of a virtual machine (operation 801). The threshold of an idle period is a time value needed to determine whether the virtual machine enters an idle state. The virtual machine is declared as entering the idle period when the difference between a time when the determination is made and a time when a thread, other than the monitor thread 604, is last blocked is greater than the threshold. The threshold must be determined in consideration of a user's pattern of use of the virtual machine and a system pattern. The meaning of the idle period will be apparent from the following description.

Once the virtual machine is driven, the execution state thread counting unit 602 counts the total number of threads that are under execution (operation 802). For example, referring to FIG. 7, since five threads are under execution (701), the execution state thread counting unit 602 records the total number of threads that are being executed as five. As time goes by, the execution state thread counting unit 602 reduces the total number of 5 by 1 whenever one of the threads is blocked.

In operation 803, it is determined whether the total number of threads under execution becomes zero. When a last one of the threads is blocked (702), the total number becomes zero (YES in operation 803).

In this case, the time stamp recording unit 603 records a time stamp indicating a time when the last thread was blocked (operation 804). Then, the last executed thread wakes up the monitor thread 604 (operation 805).

FIG. 9 is a flowchart illustrating in detail an operation of checking an idle period by using a monitor thread, which is included in a method of checking an idle period of a virtual machine, according to an exemplary embodiment of the present invention.

Referring to FIGS. 6 and 9, the monitor thread 604 stands by until it is awakened by a last blocked thread (operation 901).

The monitor thread 604 is awakened by a wake-up call (YES in operation 902). Then, the monitor thread 604 stands by again for a period of time corresponding to a threshold of an idle period (operation 903).

After the period of time corresponding to the threshold has passed, the monitor thread 604 checks the total number of threads that are under execution. In this case, the monitor thread 604 is awakened to begin operation and thus checks whether the total number is greater than 1 (operation 904). If the total number is greater than 1, it means that one or more threads other than the monitor thread are under execution, that is, the idle period has ended, and thus, the monitor thread 604 stands by again.

If the total number is equal to 1, the monitor thread 604 checks whether a thread has been executed while the monitor thread 604 stands by for the period of time corresponding to the threshold in operation 903 (operation 905). To this end, a time stamp indicating when a last thread is blocked, is used.

If the difference between the current time and the time stamp is greater than the threshold (YES in operation 905), it means that no thread has been executed while the monitor thread 604 stood by. Thus, the idle period is declared (operation 906).

However, if the difference between the current time and the time stamp is less than or equal to the threshold, it means that a thread was executed and then blocked while the monitor thread 604 stood by. Thus, it cannot be declared that the virtual machine enters the idle period, and operations 903 through 905 are performed again.

The total number of threads executed by the virtual machine continuously changes, and thus, the total number and the time stamp must be updated in real time.

The total number of threads that have yet to be blocked and a time stamp of a thread that has been last blocked can be periodically checked using an external, independent thread. However, in this case, the external thread must check information regarding all the other threads, and the states of the other threads may change even during the checking of the information, and thus, a precise result of the checking cannot be obtained.

Therefore, the present invention proposes that each thread autonomously increases or decreases the total number of threads under execution and records a time stamp, based on its own state change

Thread blocking occurs in a virtual machine when a synchronous call is used. Thus, thread blocking can be checked by a part of the virtual machine, which uses the synchronous call. That is, the total number of threads that are not blocked can be precisely updated by reducing the total number right before synchronous calling and by increasing the total number right after synchronous calling.

The following codes 1 and 2 are pseudo codes briefly showing operations that are to be performed before or after synchronous calling and blocking input/output (I/O), for idle period checking:

```
[Code 1] Pseudo Code of idleEnter
idleEnter( )
{
  Total number of threads under execution−−;  // reduce the total
  number by 1
  if (the total number == 0) {
    time stamp = current time( ); // record time when idle state begins
    wake up monitor thread;  // execute monitor thread that is in standby
    mode
  }
      }
[Code 2] Pseudo Code of idleExit
      idleExit( )
      {
        Total number of threads under execution++; // increase the total
number by 1
      }
```

As described above, the total number of threads that are under execution is reduced whenever one of the threads is in a blocking state, and a time stamp of the idle period checking device 501 is updated and the monitor thread 604 is awakened only when the total number is zero. If a thread is not in the blocking state, the total number is increased.

A case where thread execution is performed by a module outside a virtual machine will now be described.

If the outside module executes a thread, whether the thread is in the blocking state cannot be checked by the virtual machine. Thus, when the thread enters the blocking state or when the thread is not in the blocking state, an API for reporting this fact to the virtual machine needs to be made and provided to the outside module before threading. For example, when an external user performs code execution outside the virtual machine 1003 by using the JNI 1002 of FIG. 10, the virtual machine cannot realize whether the thread is blocked. In this case, when the thread enters or exits the blocking state, the JNI 1002 must inform the virtual machine of this fact via the API received from the virtual machine. Then, the idle period checking device 501 increases or reduces the total number of threads that are under execution. If a blocked thread is a last thread, a time stamp is recorded.

To this end, the API that is provided by the virtual machine to the external module is made by reflecting the functions disclosed in the above codes 1 and 2.

The present invention can be embodied as computer readable code in a computer readable recording medium. Here, the computer readable recording medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. The computer readable recording medium can be distributed among computer systems that are interconnected through a network, and the present invention may be stored and implemented as computer readable code in the distributed system. Also, the present invention can be embodied as a carrier wave that transmits data via the Internet, for example.

According to the above exemplary embodiments of the present invention, an idle period in which a virtual machine does not operate is detected and operations except for application program execution are performed in the idle period, thereby enabling efficient use of resources. In particular, in the case of a CE device, such as a DTV or a set top box, most programs are interactive programs and thus, user respondibility is very important. Accordingly, user respondibility can be improved by performing operations that would degrade user respondibility during idle periods. An experiment where compaction of garbage collection (GC) that stops a virtual machine in an idle time of the virtual machine was performed according to the present invention, revealed that moments in which a user can sense stopping of the virtual machine were reduced by approximately 60%.

While this invention has been particularly shown and described with reference to exemplary embodiments thereof, it will be understood by those of ordinary skill in the art that various changes in form and details may be made therein without departing from the spirit and scope of the invention as defined by the appended claims.

What is claimed is:

1. An apparatus for checking an idle period of a virtual machine, the apparatus comprising:
a thread counting unit which counts a total number of threads that are under execution; and
a monitor thread which detects the idle period of the virtual machine based on the total number of threads that are under execution.

2. The apparatus of claim 1, wherein the monitor thread determines that the virtual machine is in an idle state if the total number of threads under execution, except for the monitor thread, is zero.

3. The apparatus of claim 1, further comprising a time stamp recording unit which records a time stamp when a last thread from among the total number of threads that are under execution is blocked,
wherein the monitor thread determines the idle period of the virtual machine, based on the time stamp.

4. The apparatus of claim 3, further comprising an idle period threshold setting unit which sets a threshold of the idle period.

5. The apparatus of claim 4, where the threshold is set in consideration of at least one of a pattern of use of the virtual machine and a system pattern.

6. The apparatus of claim 4, wherein when the difference between a current time and a time when the last thread has been blocked is greater than the idle period threshold, the monitor thread determines that the virtual machine is in the idle state.

7. The apparatus of claim 1, wherein the apparatus further collects information indicating whether a thread is blocked from a module outside of the virtual machine.

8. The apparatus of claim 1, wherein the total number of threads that are under execution and a time stamp are updated in real time by each thread.

9. The apparatus of claim 1, wherein the virtual machine is a Java virtual machine.

10. A virtual machine comprising an apparatus for checking an idle period of the virtual machine, the apparatus comprising:
a thread counting unit which counts a total number of threads that are under execution; and
a monitor thread which detects the idle period of the virtual machine based on the total number of threads that are under execution.

11. A method of checking an idle period of a virtual machine, the method comprising:
counting a total number of threads that are under execution; and
determining whether the virtual machine is in an idle state, based on the total number of threads that are under execution.

12. The method of claim 11, wherein the determining of whether the virtual machine is in the idle state comprises declaring that the virtual machine is in the idle state if the total number of threads under execution, except for a monitor thread, is zero.

13. The method of claim 12, further comprising:
recording a time stamp indicating a time when a last thread from among the total number of threads that are under execution is blocked; and
determining whether the virtual machine is in the idle state, based on the time stamp.

14. The method of claim 13, further comprising setting a threshold of the idle period.

15. The method of claim 14, wherein when the difference between a current time and a time when the last thread has been blocked is greater than the idle period threshold, the determining whether the virtual machine is in the idle state comprises declaring that the virtual machine is in the idle state.

16. The method of claim 12, wherein the determining whether the virtual machine is in the idle state further comprises:
the monitor thread standing by; and
the monitor thread receiving a wake-up call.

17. The method of claim 12, wherein the determining whether the virtual machine is in the idle state further comprises the monitor thread standing by for a period of time corresponding to a threshold of the idle period.

18. The method of claim 11, further comprising updating the total number of the threads under execution and a time stamp in real time.

19. The method of claim 18, wherein the updating of the total number of the threads under execution and a time stamp in real time, is performed by each thread.

20. The method of claim 13, further comprising updating the total number of the threads under execution and a time stamp in real time.

21. The method of claim 20, wherein the updating of the total number of the threads under execution and a time stamp in real time, is performed by each thread.

22. The method of claim 21, wherein the updating of the total number of the threads under execution and a time stamp in real time, is performed before or after each thread that is blocked.

23. The method of claim 11, further comprising collecting from a module outside of the virtual machine, information indicating whether a thread is blocked.

24. The method of claim 23, further comprising providing to the module outside of the virtual machine, an application program interface for collecting the information indicating whether a thread is blocked.

25. A computer readable recording medium having recorded thereon a computer program for executing a method of checking an idle period of a virtual machine, the method comprising:
counting a total number of threads that are under execution; and
determining whether the virtual machine is in an idle state, based on the total number of threads that are under execution.
